(19) United States
(12) Patent Application Publication
(10) Pub. No.: US 2008/0066218 A1
(43) Pub. Date: Mar. 20, 2008

(54) Hard hat outer shell having clear acrylic construction and internal illumination

(75) Inventor: Larry J. Loizzo, Janesville, WI (US)

Correspondence Address: GREENBERG TRAURIG, LLP, 77 WEST WACKER DRIVE, SUITE 2500, CHICAGO, IL, 60601-1732, US

(73) Assignee: W.W. Grainger, Inc., Lake Forest, IL (US)

(21) Appl. No.: 11/901,935

(22) Filed: Sep. 19, 2007

Related U.S. Application Data
(60) Provisional application No. 60/845,629, filed on Sep. 19, 2006.

(51) Int. Cl. A42B 1/24; A42B 1/00; F21V 21/00; A42B 1/02

(52) U.S. Cl. 2/422; 2/410; 362/105; 362/106

(57) ABSTRACT

A hard hat which includes an outer shell constructed entirely of clear acrylic that is additionally provided with a means to internally illuminate the clear acrylic outer shell.

### BACKGROUND

In the art various methods for constructing hard hats or safety helmets are known. For example, U.S. Pat. No. 5,810,467 describes an illuminated protective hard hat that includes an electroluminescent lamp that is secured to the outside of an outer shell of the hard hat. U.S. Pat. No. 5,544,027 describes a safety helmet in which a string of LEDs are affixed, using an adhesive, to an outer shell of the safety helmet. U.S. Pat. No. 5,871,271 describes a safety helmet having an outer shell wherein one or more LEDs are fitted into recesses formed in the outer shell of the safety helmet. U.S. Pat. No. 6,497,493 describes a hard hat having a mounting bracket for supporting a battery-powered light on an exterior portion of an outer shell of the hard hat. U.S. Pat. No. D354,160 illustrates a design for a hard hat and a hard hat liner. In addition, ANSI Z89.1-2003 of the American National Standard for Industrial Head Protection describes the physical requirements for protective hard hats. Each of these references is hereby incorporated by reference in its entirety.

### SUMMARY

The subject invention is directed to an improved hard hat which includes an outer shell constructed entirely of clear acrylic that is additionally provided with a means to internally illuminate the clear acrylic outer shell. The various objects, advantages, features, properties and relationships of this improved hard hat will be obtained from the following detailed description and accompanying drawing that set forth illustrative embodiments that are indicative of the various ways in which the principles expressed hereinafter may be employed.

### BRIEF DESCRIPTION OF THE DRAWINGS

For a better understanding of the improved hard hat described hereinafter reference may be had to preferred embodiments shown in the following drawings in which:

FIG. 1 illustrates a partial view of an exemplary hard hat having an outer shell constructed using a clear acrylic;

FIG. 2 illustrates a partial view of the hard hat of FIG. 1 wherein a first exemplary illumination system is utilized to internally illuminate the outer shell of the hard hat; and

FIG. 3 illustrates a partial view of the hard hat of FIG. 1 wherein a second exemplary illumination system is utilized to internally illuminate the outer shell of the hard hat.

### DETAILED DESCRIPTION

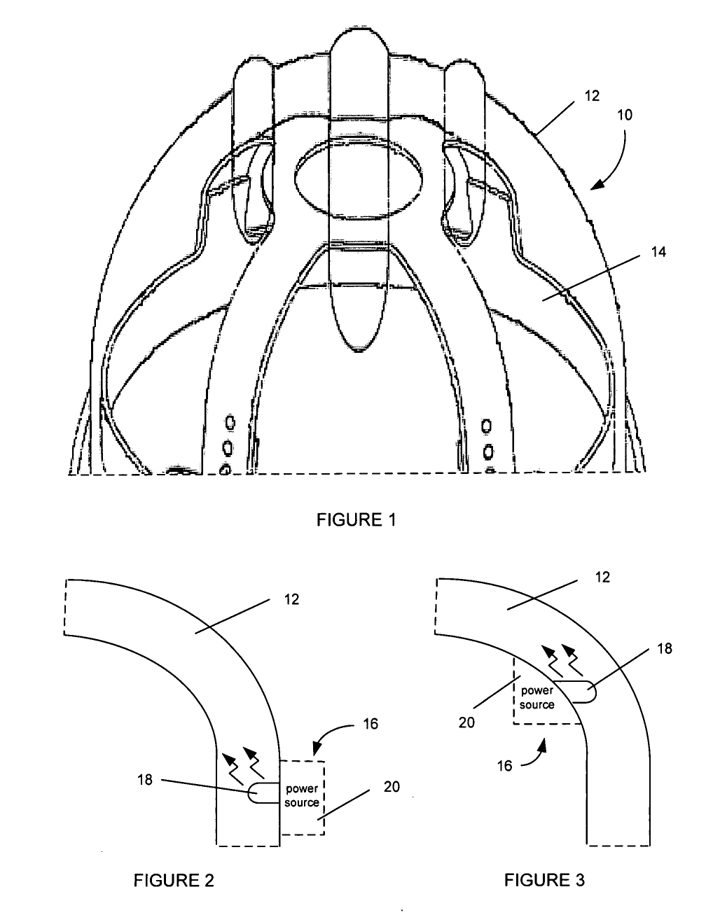

With reference to the figures, an improved hard hat is hereinafter described. As is conventional, the improved hard hat 10 includes an outer shell 12 and a harness 14. As will be understood, the harness 14 functions to maintain the hard hat 10 in correct wearing position on the head of a wearer and to act as an energy-absorbing mechanism. The entirety of the outer shell 12 is formed from a clear acrylic and, as such, the harness 14 will generally be visible through the outer shell 12 as illustrated in FIG. 1.

To internally illuminate the clear acrylic outer shell 12 of the helmet 10, an illumination device 16 is provided. The illumination device 16 is preferably in the form of an LED 18 that is fused into the clear acrylic outer shell 12. The LED 18 is powered by means of a power source 20 which may be in the form of batteries, a rechargeable power supply, etc. By way of example, the power source 20 may be attached to an exterior portion of the outer shell 12 of the helmet 10 as illustrated in FIG. 2. By way of further example, the power source 20 may be attached to an interior portion of the outer shell 12 of the helmet 10 in an area between the outer shell 12 and the harness 14 as illustrated in FIG. 3. In either case, the power source 20 may be releasably attached to the outer shell 12, for example by using clips, brackets, or the like, or may be integrally attached to the outer shell 12 and, if needed, provided with a releasable cover to thereby allow for replacement of batteries. For causing illumination of the LED 18, the power source 20 may be coupled to a manually operable switch. The power source 20 may also or alternatively be coupled to an automatic switch, such as a light sensing circuit, to allow for the turning on and off of the LED 18 based upon certain sensed conditions. The LED 18 may also be caused to be illuminated continuously and/or caused to blink as desired. Still further, the LED 18 may be a multicolored LED with a switch being used to select a particular color in which to internally illuminate the clear acrylic outer shell 12. While a single illumination device 16 with a single LED 18 is illustrated, it is to be understood that the hard hat 10 may support multiple illumination devices 16 and that the illumination device 16 may support more than one LED 18.

While specific embodiments of the improved hard hat have been described in detail, it will be appreciated by those skilled in the art that various modifications and alternatives to those details could be developed in light of the overall teachings of the disclosure. Accordingly, the particular arrangement disclosed is meant to be illustrative only and not limiting as to the scope of the invention which is to be given the full breadth of the appended claims and any equivalents thereof.

What is claimed is:

1. A hard hat comprising:
an outer shell; and
a harness attached to the outer shell;
wherein the outer shell is formed using a clear acrylic such that the entirety of the outer shell is transparent.

2. The hard hat as recited in claim 1, comprising an illumination device for illuminating the interior of the clear acrylic outer shell.

3. The hard hat as recited in claim 2, wherein the illumination device comprises an LED fused into the clear acrylic outer shell.

4. The hard hat as recited in claim 3, wherein the LED comprises a multicolor LED.

5. The hard hat as recited in claim 3, wherein the illumination device comprises a power source attached to an exterior portion of the clear acrylic outer shell used to provide power for illuminating the LED.

6. The hard hat as recited in claim 3, wherein the illumination device comprises a power source attached to an interior portion of the clear acrylic outer shell used to provide power for illuminating the LED.

7. The hard hat as recited in claim 5, wherein the power source is detachable from the clear acrylic outer shell.

8. The hard hat as recited in claim 6, wherein the power source is detachable from the clear acrylic outer shell.

9. The hard hat as recited in claim 5, wherein the power source is rechargeable.

10. The hard hat as recited in claim 6, wherein the power source is rechargeable.

11. The hard hat as recited in claim 3, wherein the LED is caused to illuminate as a function of a sensed lighting condition.

12. The hard hat as recited in claim 3, wherein the LED is manually caused to be illuminated.
